(19) United States
(12) Patent Application Publication
(10) Pub. No.: US 2026/0036920 A1
(43) Pub. Date: Feb. 5, 2026

(54) TONER FOR DEVELOPMENT OF ELECTROSTATIC LATENT IMAGES

(71) Applicant: KYOCERA Document Solutions Inc., Osaka (JP)

(72) Inventor: Ken MAETANI, Osaka (JP)

(73) Assignee: KYOCERA Document Solutions Inc., Osaka (JP)

(21) Appl. No.: 19/270,864

(22) Filed: Jul. 16, 2025

(30) Foreign Application Priority Data
Aug. 5, 2024 (JP) 2024-128660

(51) Int. Cl. G03G 9/093; G03G 9/08; G03G 9/09

(52) U.S. Cl. CPC G03G 9/09371; G03G 9/0827; G03G 9/0918; G03G 9/09328

(57) ABSTRACT

Toner for development of electrostatic latent images includes a toner particle having a toner core particle and a shell layer. The shell layer is formed of resin fine particles containing vinyl-based resin and including a plurality of types of first resin fine particles and second resin fine particles. The shell layer has a sea-like region formed of the plurality of types of first resin fine particles and island-like bumps formed of the second resin fine particles with a larger average particle size than the first resin fine particles. At least one type of first resin fine particles contains a quaternary ammonium compound and the second resin fine particles contain silicone resin. The average particle size of the second resin fine particles is from 70 nm to 150 nm, and the ratio of coverage of the surface of the toner core particle with the bumps is from 10% and 50%.

### INCORPORATION BY REFERENCE

This application is based on and claims the benefit of priority from Japanese Patent Application No. 2024-128660 filed on Aug. 5, 2024, the contents of which are hereby incorporated by reference.

### BACKGROUND

The present disclosure relates to toner for development of electrostatic latent images.

In general, in an electrophotographic method, the surface of an electrostatic latent image carrying member is electrostatically charged by corona discharge or the like and is then exposed to laser light or the like to form an electrostatic latent image. The formed electrostatic latent image is developed with toner to form a toner image. The formed toner image is transferred to a recording medium to produce a high-quality image. Typically, as toner for use in an electrophotographic method, a binder resin such as a thermoplastic resin is blended with a colorant, a charge control agent, a release agent, a magnetic material, and the like and the mixture is then subjected to kneading, pulverization, and classification to obtain toner particles (toner base particles) with an average particle size of 5 μm or more but 10 μm or less. Then, for the purposes of making the toner flowable, giving it satisfactory charging properties, and improving the cleaning properties of the toner against a photosensitive drum, an inorganic fine powder such as silica or titanium oxide is externally added to the toner base particles.

One known type of toner used as such toner has a core-shell structure in which a toner core particle employing a low-melting-point binder resin is coated with a shell layer of a resin with a glass transition point higher than the glass transition point of the binder resin of the toner core particle for the purposes of obtaining satisfactory fixing properties in a low temperature range, improving preservation stability at high temperature, improving blocking resistance, and the like.

### SUMMARY

According to one aspect of the present disclosure, toner for development of an electrostatic latent image includes a toner particle having a toner core particle and a shell layer. The toner core particle at least contains a binder resin, a release agent, and a colorant. The shell layer coats the toner core particle. The shell layer is formed of resin fine particles containing a vinyl-based resin. The resin fine particles include a plurality of types of first resin fine particles and second resin fine particles with a larger average particle size than the first resin fine particles. The shell layer has a sea-like region formed of the plurality of types of first resin fine particles and island-like bumps formed of the second resin fine particles and spread across the sea-like region. At least one type of first resin fine particles contains a quaternary ammonium compound and the second resin fine particles contain a silicone resin. The average particle size of the second resin fine particles is 70 nm or more but 150 nm or less. The ratio of coverage of the surface of the toner core particle with the bumps is 10% or more but 50% or less.

### BRIEF DESCRIPTION OF THE DRAWINGS

FIG. 1 is a diagram showing one example of the sectional structure of toner according to the present disclosure for development of electrostatic latent images.

FIG. 2 is a schematic diagram showing, on an enlarged scale, part of a section of the toner shown in FIG. 1 for development of electrostatic latent images.

### DETAILED DESCRIPTION

An embodiment of the present disclosure will be described in detail below. Unless otherwise defined, a result of evaluation (i.e., a value related to a shape, property, or the like) with respect to a powdery substance (specifically, toner core particle, toner base particle, external additive, toner, and the like) is given as a number average of values obtained respectively for an appropriate number of average particles selected from the powdery substance. Unless otherwise defined, a number average particle size of a powdery substance is a number average value of the circle-equivalent diameter (the diameter of a circle with the same area as the projection area of a particle) of primary particles measured under a microscope. Unless otherwise defined, a measured value of the volume median diameter (D50) of a powdery substance is a value measured using a laser diffraction/scattering particle size distribution analyzer (“LA-750” produced by Horiba Ltd.). Unless otherwise defined, a measured value of an acid number or a hydroxy group number is a value measured in conformity with JIS (Japanese Industrial Standards) K0070-1992. Unless otherwise defined, a measured value of a number average molecular weight (Mn) or a mass average molecular weight (Mw) is a value measured by gel permeation chromatography.

In the following description, “-based” is occasionally appended to the name of a compound to collectively refer to that substance and their derivatives. Wherever the name of a compound has “-based” appended to it in the name of a polymer, the recurring unit in the polymer is derived from any of that compound and their derivatives. The term “(meth)acrylic” is occasionally used to refer to “acrylic” and “methacrylic” collectively. The term “(meth)acryloyl is occasionally used to refer to “acryloyl” (CH₂═CH—CO—) and “methacryloyl” (CH₂═C(CH₃)—CO—) collectively.

Toner according to the embodiment can be used, for example, as positively chargeable toner suitably for development of electrostatic latent images. The toner according to the embodiment is a powdery substance containing a plurality of toner particles (each configured as described later). The toner can be used as one-component developer. The toner can be mixed with carrier using a mixing apparatus (e.g., a ball mill) to prepare two-component developer. To form high-quality images, it is preferable to use ferrite carrier as the carrier. To form high-quality images over a long period, it is preferable to use magnetic carrier particles that have a carrier core and a resin layer coating the carrier core. To produce magnetic carrier particles, the carrier core can be formed with a magnetic material (e.g., ferrite) or the carrier core can be formed with resin having magnetic particles dispersed in it. Or, magnetic particles can be dispersed in the resin layer coating the carrier core. To form high-quality images, the amount of toner in two-component developer is preferably 5 mass parts or more but 15 mass parts or less for 100 mass parts of carrier. Positively chargeable toner is charged positive by friction with carrier.

The toner particles contained in the toner according to the embodiment have a core (hereinafter referred to as the toner core particle) and a shell layer (capsule layer) formed on the surface of the toner core particle. The shell layer is formed substantially of resin. For example, by coating a toner core particle that melts at low temperature with a shell layer that has high resistance to heat, it is possible to give the toner satisfactory heat-resistant preservation properties and low-temperature fixing properties. An additive can be dispersed in the resin forming the shell layer. The shell layer can cover the entire surface of the toner core particle, or can partly cover the surface of the toner core particle. An external additive can be attached to the surface of the shell layer (or a surface region of the toner core that is not covered by the shell layer). Unless necessary, the external additive can be omitted. Toner that chiefly contains toner particles with a shell layer can contain toner particles with no shell layer. In the following description, a toner particle before an external additive is attached to it is referred to as a toner base particle. A material for forming a toner core particle is referred to as a toner core material. A material for forming a shell layer is referred to a shell material.

The toner according to the embodiment can be used, for example, to form images on an electrophotographic apparatus (image forming apparatus). One example of an image formation method on an electrophotographic apparatus will be described below.

First, based on image data, an electrostatic latent image is formed on a photosensitive member (e.g., in a superficial part of a photosensitive drum). Next, the formed electrostatic latent image is developed with developer containing toner. In the development process, toner (e.g., toner electrostatically charged by friction with carrier or a blade) on a development sleeve (e.g., a superficial part of a development roller in a developing device) disposed near the photosensitive member is attached to the electrostatic latent image to form a toner image on the photosensitive member. In the subsequent transfer process, the toner image on the photosensitive member is transferred directly to a recording medium (e.g., paper); or it is first primarily transferred to an intermediate transfer member (e.g., transfer belt) and then the toner image on the intermediate transfer member is secondarily transferred to a recording medium. After that, the toner is heated so that the toner is fixed to the recording medium. In this way, an image is formed on the recording medium. By superposing on each other toner images of four colors, for example, black, yellow, magenta, and cyan, it is possible to form a full-color image.

### [1. Basic Configuration of Toner]

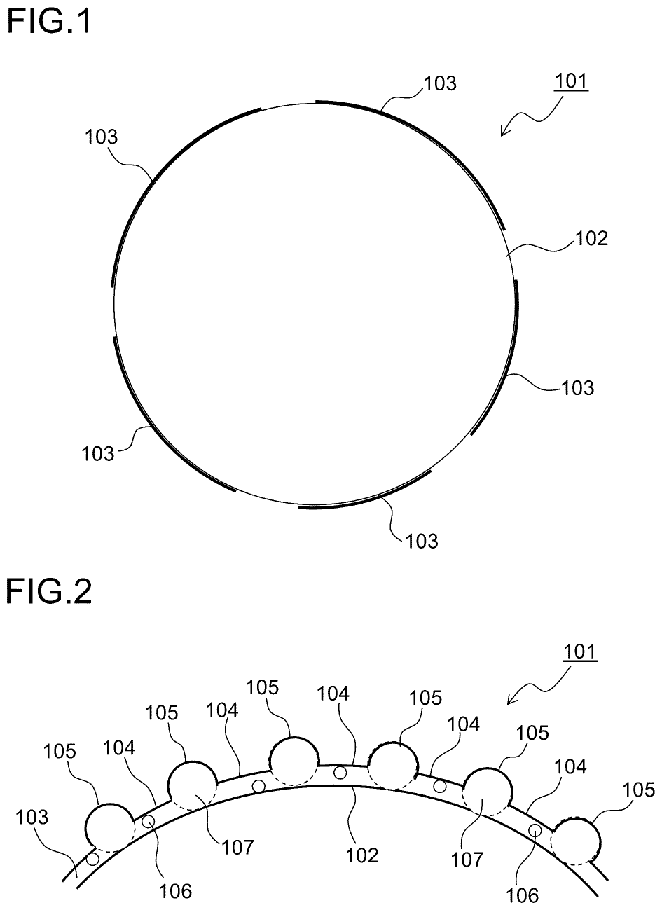

FIG. 1 is a diagram showing one example of the sectional structure of the toner according to the present disclosure for development of electrostatic latent images, of which the basic configuration has been described above. As shown in FIG. 1, the toner 101 according to the present disclosure for development of electrostatic latent images (in the following description, often referred to simply as the toner) has a toner core particle 102 of which the surface is coated by a shell layer 103. The toner core particle 102 at least contains a binder resin, a release agent, and a colorant.

The thickness of the shell layer 103 is not particularly limited within the scope consistent with the object of the present disclosure; it is preferably 0.03 μm or more but 1 μm or less, more preferably 0.04 μm or more but 0.7 μm or less, particularly preferably 0.05 μm or more but 0.5 μm or less, and most preferably 0.05 μm or more but 0.3 μm or less. In the toner 101 according to the present disclosure, the shell layer 103 has bumps 105 (see FIG. 2) and thus has an uneven thickness. Accordingly, in the present specification, the thickness of the thickest part (bumps 105) of the shell layer 103 is taken as the thickness of the shell layer.

If the shell layer 103 has too large a thickness, when the toner 101 is fixed to the recording medium, the pressure applied to the toner 101 may fail to break the shell layer 103. In that case, the binder resin and the release agent contained in the toner core particle 102 does not soften or melt quickly, leading to difficulty in fixing the toner to the recording medium in a low-temperature range. On the other hand, if the shell layer 103 has too small a thickness, it has low mechanical strength. With low mechanical strength, the shell layer 103 may break under impact during transport. Thus, if the toner 101 is stored at high temperature, for example, the release agent may seep out through a broken part of the shell layer 103 onto the surface of the toner 101, making the toner 101 difficult to agglomerate.

The thickness of the shell layer 103 can be measured by inspecting a section of the toner 101 on a transmission electron microscope (TEM) and analyzing a TEM scan image with commercially available image analysis software. One example of usable commercially available image analysis software is WinROOF (produced by Mitani Corporation).

In the toner 101 according to the present disclosure, the toner core particle 102 need not have its entire surface coated by the shell layer 103. To give the toner 101 satisfactory heat-resistant preservation properties and low-temperature fixing properties, it is preferable that the shell layer 103 cover 50% or more but 99% or less of the area of the superficial region of the toner core particle 102. The entire surface of the toner core particle 102 can be coated with the shell layer 103.

The condition of the coating of the surface of the toner 101 with the shell layer 103 can be checked on a scanning electron microscope (SEM). The condition of the formation of the bumps 105 of the shell layer 103 and the inside of the shell layer 103 of the toner 101 can be checked by inspecting a section of the toner 101 on a transmission electron microscope (TEM).

FIG. 2 is a schematic diagram showing part of a section of the toner 101 in FIG. 1. In the toner 101 according to the present disclosure, the shell layer 103 has a sea-like region 104 and a plurality of island-like bumps 105. That is, the surface of the toner core particle 102 is coated by the sea-like region 104 and the bumps 105 of the shell layer 103. This is advantageous to achieving satisfactory heat-resistant preservation properties and low-temperature fixing properties.

The shell layer 103 is formed of at least two types of vinyl-based resin fine particles 106 and 107 with different average particle sizes respectively. The sea-like region 104 is formed of the vinyl-based resin fine particles (first resin fine particles) 106 with a relatively small average particle size. The bumps 105 are formed of the vinyl-based resin fine particles (second resin fine particles) 107 with a relatively large average particle size.

The sea-like region 104 is formed of a plurality of types of first resin fine particles 106. Of the plurality of types of first resin fine particles 106, at least one contains a quaternary ammonium compound. Owing to the sea-like region 104 containing a quaternary ammonium compound, the toner 101 has stable positive chargeability at low cost.

In the toner 101 according to the present disclosure, the shell layer 103 has on its surface a plurality of bumps 105 and this permits the bump 105 to function as a spacer. This helps, as compared with a shell layer 103 with no bumps 105, to reduce the contact area of the toner 101 with a photosensitive drum or with an intermediate transfer belt.

This makes the toner 101 less prone to adhere to the photosensitive drum, the intermediate transfer belt, or the like and thus improves the cleaning properties (e.g., resistance to adhesion to the photosensitive drum) and the developing properties (e.g., transfer efficiency) of the toner 101.

The bumps 105 at least contain a silicon polymer. Owing to the bumps 105 containing a silicon polymer, the bumps 105 exhibits less adhesion. This improves the release properties of the toner 101 in contact with the photosensitive drum or the intermediate transfer belt and helps maintain satisfactory transferring properties. The bumps 105 cover 10% to 50% of the entire surface of the toner core particle 102.

With the basic configuration described above, the toner 101 according to the present disclosure is expected to provide satisfactory positive chargeability in a normal-temperature normal-humidity environment as well as in a high-temperature high-humidity environment. The toner 101 is thus expected to produce high-quality images (e.g., images with a low fog density) in a normal-temperature normal-humidity environment as well as in a high-temperature high-humidity environment.

On the surface of the 103, preferably, the bumps 105 constitute a positively chargeable region. In a case where the toner 101 is mixed with magnetic carrier to prepare two-component developer, the bumps 105 of the shell layer 103 easily make contact with the carrier. Thus, with the bumps 105 constituting a positively chargeable region, the toner 101 is expected to be easy to charge by friction.

For the toner 101 to have satisfactory positive chargeability in an normal-temperature normal-humidity environment as well as in a high-temperature high-humidity environment, preferably, the bumps 105 (positively chargeable region) are evenly spread across the surface of the shell layer 103. A spread positively chargeable region, that is, one that is not concentrated in one place, helps improve the positive chargeability of the toner 101 over its entire surface. It is also possible to give the toner stable release properties against the photosensitive drum and the intermediate transfer belt.

### [2. Materials of Toner]

Next, a description will be given of the essential or optional components of the toner according to the present disclosure. The toner core particle contains, in the binder resin, at least a release agent and a colorant. It can further contain, as necessary, a charge control agent, a magnetic powder, and the like. The toner according to the present disclosure can, if so desired, have its surface treated with an external additive.

Now, a description will be given one by one of the binder resin, the release agent, the charge control agent, and the colorant that form the toner core particle, the resin fine particles that form the shell layer, and the external additive as well as the method of producing the toner according to the present disclosure.

### (Binder Resin).

In the toner according to the present disclosure, the toner core particle contains a binder resin. The binder resin that can be contained in the toner core particle is not particularly limited so long as it is a resin known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, polyester resins are preferred from the viewpoints of the dispersion properties of the colorant in the binder resin, the charging properties of the toner, and the fixing properties on sheets. Hereinafter, a description will be given of the polyester resin.

Usable as polyester resins are those obtained by condensation polymerization or condensation copolymerization of a dihydric or a trihydric or higher alcohol component and a divalent or a trivalent or higher carboxylic acid component. Examples of components used to synthesize a polyester resin include alcohol components and carboxylic acid components as mentioned below.

Specific examples of dihydric or trihydric or higher alcohol components include diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butantriol, 1,2,5-pentantriol, glycerol, diglycerol, 2-methylpropan triol, 2-methyl-1,2,4-butantriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebatic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane thicarboxylic acid, 1,3-dicarboxyl-2-methyl-2-methylenecarboxypropane, 1,2,4-cyclohexane tricarboxylic acid, tetra (methylene carboxyl) methane, 1,2,7,8-octane tetracarboxylic acid, pyromellitic acid, and empole trimer acid. These divalent or trivalent or higher carboxylic acid components can be used as ester-forming derivatives such as acid halides, acid anhydrides, and lower alkyl esters. Here, the term “lower alkyl” denotes an alkyl group with one to six carbon atoms.

When the binder resin is a polyester-based resin, the softening point of the polyester-based resin is preferably 70° C. or more but 130° C. or less, and more preferably 80° C. or more but 120° C. or less. For improved mechanical strength of the toner core and improved fixing properties of the toner, the number average molecular weight (Mn) of the polyester resin is preferably 1000 or more but 2000 or less. The molecular weight distribution of the polyester resin (the ratio Mw/Mn of the mass average molecular weight (Mw) of the polyester resin to its number average molecular weight (Mn)) is preferably 9 or more but 21 or less.

As the binder resin, it is preferable to use a thermoplastic resin for its satisfactory fixing properties on sheets. Here, a thermoplastic resin can be used not only singly but also with a cross-linking agent or a thermosetting resin added to it. Adding a cross-linking agent or a thermosetting resin so that the binder resin partly have a cross-linked structure helps improve the heat-resistant preservation properties, durability, and the like of the toner without degrading the fixing properties of the toner. When a thermosetting resin is used, the cross-linked fraction (gel fraction) of the binder resin extracted using a Soxhlet extractor is preferably, relative to the mass of the binder resin, 10 mass % or less, and more preferably 0.1 mass % or more but 10 mass % or less.

As a thermosetting resin useable with a thermoplastic resin, an epoxy resin or a cyanate-based resin is preferred. Specific examples of suitable thermosetting resins include bisphenol A-type epoxy resins, hydrogenated bisphenol A-type epoxy resins, novolak-type epoxy resins, polyalkylene ether-type epoxy resins, cyclic aliphatic compound-type epoxy resins, and cyanate resins. Two or more of these thermosetting resins can be used in combination.

The glass transition point (Tg) of the binder resin is preferably 40° C. or more but 70° C. or less. Too high a glass transition point tends to lead to poor low-temperature fixing properties of the toner. Too low a glass transition point tends to lead to poor heat-resistant preservation properties.

The glass transition point of the binder resin can be determined from the changing point of the specific heat of the binder resin using a differential scanning calorimeter (DSC). More specifically, the glass transition point of the binder resin can be determined by drawing the endothermic curve of the binder resin using as a measuring instrument a differential scanning calorimeter (“DSC-6220” produced by Seiko Instruments Inc.). 10 mg of a measurement sample is put in an aluminum pan, while a vacant aluminum pan is used as a reference. From the endothermic curve of the binder resin drawn through measurement in a normal-temperature normal-humidity environment in the range of measurement temperature from 25° C. to 200° C. at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polyethylene resin.

### (Release Agent)

For the purpose of improving its fixing properties and offset properties, the toner core particle contains a release agent. The type of release agent that can be contained in the toner core particle is not limited within the scope consistent with the object of the present disclosure. As the release agent, wax is preferred. Examples of wax include carnauba wax, synthetic ester wax, polyethylene wax, polypropylene wax, fluorocarbon-based wax, Fischer-Tropsch wax, paraffin wax, montan wax, and rice wax. Two or more of these release agents can be used in combination. Adding these release agents to the toner core particle 102 helps more effectively suppress offsetting and image smearing (stain around an image caused by its being rubbed).

When polyester resin is used as the binder resin, from the viewpoint of compatibility, one or more selected from the group consisting of carnauba wax, synthetic ester wax, and polyethylene wax are suitably used. When polystyrene resin is used as the binder resin, likewise from the viewpoint of compatibility, Fischer-Tropsch wax and/or paraffin wax is suitably used.

Fischer-Tropsch wax is a straight-chain hydrocarbon compound with few iso-structure molecules or side chains that is produced by exploiting the Fischer-Tropsch reaction, which is a catalytic hydrogenation reaction of oxygen monoxide.

Preferred among different types of Fischer-Tropsch wax are those that have a mass average molecular weight of 1,000 or more and of which the bottom temperature of the exothermal peak observed by DSC measurement falls within the range of 100° C. or more but 120° C. or less. Examples of such types of Fischer-Tropsch include the following products available from Sasol: Sasol Wax C1 (exothermic peak bottom temperature: 106.5° C.), Sasol Wax C105 (exothermic peak bottom temperature: 102.1° C.), and Sasol Wax Spray (exothermic peak bottom temperature: 102.1° C.).

The amount of release agent used is not particularly limited within the scope consistent with the object of the present disclosure. Specifically, the amount of release agent used is preferably 1 mass % or more but 10 mass % or less of the total mass of the toner core particle 102. Too small an amount of release agent used can result in insufficient suppression of offsetting and image smearing in image formation; too large an amount of release agent used can result in fusing-together of toner particles and hence poor heat-resistant preservation properties.

### (Colorant)

The toner core particle contains a colorant. As the colorant that can be contained in the toner core particle, any known pigment or dye that suits the color of the toner can be used. Specific examples of suitable colorants that can be added to the toner include black pigments such as carbon black, acetylene black, lamp black, and aniline black; yellow pigments such as chrome yellow, zinc yellow, cadmium yellow, yellow iron oxide, mineral fast yellow, nickel titanium yellow, Naples yellow, naphthol yellow S, Hansa yellow G, Hansa yellow 10G, benzidine yellow G, benzidine yellow GR, quinoline yellow lake, permanent yellow NCG, tartrazine lake, monoazo yellow, and diazo yellow; orange pigments such as reddish chrome yellow, molybdenum orange, permanent orange GTR, pyrazolone orange, Vulcan Orange, and indanthrene brilliant orange GK; red pigments such as red iron oxide, cadmium red, red lead, mercury cadmium sulfide, Permanent Red 4R, lithol red, pyrazolone red, Watchung red calcium salt, lake red D, brilliant carmine 6B, cosine lake, rhodamine lake B, alizarin lake, brilliant carmine 3B, and monoazo red; violet pigments such as manganese violet, fast violet B, and methyl violet lake; blue pigments such as Prussian blue, cobalt blue, alkali blue lake, partially chlorinated Victoria blue, fast sky blue, indanthrene blue BC, and phthalocyanine blue; green pigments such as chrome green, chromium oxide, pigment green B, malachite green lake, and final yellow green G; white pigments such as zinc white, titanium oxide, antimony white, and zinc sulfide; and extender pigments such as barite powder, barium carbonate, clay, silica, white carbon, talc, and alumina white. Two or more of these pigments can be used in combination for the purpose, among others, of adjusting the toner to the desired hue.

The amount of colorant used is not particularly limited within the scope consistent with the object of the present disclosure. Specifically, the amount of colorant used is preferably 1 mass % or more but 10 mass % or less of the total mass of the toner core particle, and more preferably 2 mass % or more but 7 mass % or less.

A colorant can be used as a master batch having a colorant previously dispersed in a resin material such as a thermoplastic resin. When a colorant is used as a master batch, the resin contained in the master batch is preferably a resin of the same type as the binder resin.

### (Charge Control Agent)

The toner core particle can contain a charge control agent for the purpose of improving the charge level of the toner and its charge response properties as an index of whether it can be charged to a predetermined charge level in a short time and thereby obtaining toner with excellent durability and stability. In development with toner positively charged, a positively chargeable charge control agent is used; in development with toner negatively charged, a negatively chargeable charge control agent is used.

The type of charge control agent that can be contained in the toner core particle is not particularly limited within the scope consistent with the object of the present disclosure. Any of charge control agents known to be used in toner can be appropriately selected and used. Specific examples of positively chargeable charge control agents include azine compounds such as pyridazine, pyrimidine, pyrazine, orthoxazine, metaoxazine, paraoxiazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes composed of azine compounds, such as azine fast red FC, azine fast red 12BK, azine violet BO, azine brown 3G, azine light brown GR, azine dark green BH/C, azine deep black EW, and azine deep black 3RL; nigrosine compounds such as nigrosine, nigrosine salts, and nigrosine derivatives; acid dyes composed of nigrosine compounds, such as nigrosine BK, nigrosine NB, and nigrosine Z; metal salts of naphthenic acid or higher fatty acids; alkoxylated amines; alkylamides; and quaternary ammonium salts such as benzylmethylhexyldecylammonium and decyltrimethylammonium chloride. Among these positively chargeable charge control agents, nigrosine compounds are particularly preferred for their faster charge response properties. Two or more of these positively chargeable charge control agents can be used in combination.

Also usable as a positively chargeable charge control agent are resins that have as a functional group a quaternary ammonium salt, a carboxylic acid salt, or a carboxyl group. Specific examples include styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins are not particularly limited within the scope consistent with the object of the present disclosure, and they can be in the form of an oligomer or a polymer.

Among resins usable as a positively chargeable charge control agent, from the viewpoint of easy adjustment of the amount of charge within a desired range, styrene-acrylic-based resin having as a functional group a quaternary ammonium salt is more preferred. In styrene-acrylic-based resins having as a functional group a quaternary ammonium salt, specific examples of preferred acrylic-based comonomers for copolymerization with the styrene unit include esters of alkyl (meth)acrylates such as methyl acrylate, ethyl acrylate, n-propyl acrylate, isopropyl acrylate, n-butyl acrylate, isobutyl acrylate, 2-ethylhexyl acrylate, methyl methacrylate, ethyl methacrylate, n-butyl methacrylate, and isobutyl methacrylate.

Used as a quaternary ammonium salt is a unit derived by a quaternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethylaminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acryl amide include dimethyl methacryl amide. Specific examples of dialkyl aminoalkyl (meth)acryl amide include dimethyl aminopropyl methacryl amide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamid can be used together.

Specific examples of negatively chargeable charge control agents include organic metal complexes, chelate compounds, monoazo metal complexes, acetylacetone metal complexes, aromatic hydroxycarboxylic acids, aromatic dicarboxylic acid-based metal complexes, aromatic monocarboxylic acids, and aromatic polycarboxylic acids along with their metal salts, anhydrides, and esters, as well as phenol derivatives such as bisphenol. Among these, organic metal complexes and chelate compounds are preferred. More preferred as organic metal complexes and chelate compounds are acetylacetone metal complexes such as aluminum acetylacetonate and iron (II) acetylacetonate, and salicylic acid-based metal complexes and salicylic acid-based metal salts such as chromium 3,5-di-tert-butyl salicylate, particularly preferred being salicylic acid-based metal complexes and salicylic acid-based metal salts. Two or more of these negatively chargeable charge control agents can be used in combination.

The amount of positively or negatively chargeable charge control agent used is not particularly limited within the scope consistent with the object of the present disclosure. Typically, the amount of positively or negatively chargeable charge control agent used is preferably 0.1 mass % or more but 10 mass % or less of the total mass of the toner core particle. Too small an amount of charge control agent used makes it difficult to stably charge the toner with a predetermined polarity. This can lead to a lower-than-expected image density in the formed image and make it difficult to maintain satisfactory image density for a long period. Also the charge control agent is then difficult to disperse evenly, and this tends to cause fogging in the formed image and contamination of a latent image carrying member with toner components. Too large an amount of charge control agent used leads to poorer resistance to environment, resulting in image faults in the formed image due to insufficient charging under high temperature and high humidity and contamination of a latent image carrying member with toner components.

### (Resin Fine Particles)

In the toner according to the present disclosure, the shell layer is formed of resin fine particles. The resin fine particles are formed of a resin that contains a charge control resin. Thus, as the resin fine particles used to form the shell layer, resin fine particles formed of a resin containing a charge control resin are used. Owing to the shell layer being formed of a resin containing a charge control resin, when images are formed for a long period in various environments such as a high-temperature high-humidity environment and a low-temperature low-humidity environment, it is possible to charge the toner with the desired charge amount and to form images with the desired density.

In the toner according to the present disclosure, the shell layer contains vinyl-based resin fine particles with a relatively small particle size (first resin fine particles) and vinyl-based resin fine particles with a relatively large particle size (second resin fine particles). The first resin fine particles form the sea-like region of the shell layer; the second resin fine particles form the bumps of the shell layer. The average particle size of the first resin fine particles is preferably between about 10 nm and 40 nm. The average particle size of the second resin fine particles is preferably between about 70 nm and 150 nm.

The first and second resin fine particles are preferably formed of styrene-acrylic-based resin containing a styrene-based monomer and one or more types of acrylic acid-based monomers. Styrene-acrylic-based resin is highly hydrophobic and tends to be easily charged positively. The first and second resin fine particles both being styrene-acrylic-based resin results in high compatibility between them, and this is considered to suppress the coming-off of the shell layer at the bumps. Suppressing the coming-off of the shell layer at the bumps helps maintain the surface shape of the shell layer for a long period and hence helps maintain the function of the bumps on the surface of the shell layer for a long period. These effects are considered to be obtained even if the first and second resin fine particles are formed of styrene-acrylic-based resin of completely the same composition (i.e., even if they differ in the type of styrene-based monomer and/or acrylic acid-based monomer) so long as they are both styrene-acrylic-based resin.

The first resin fine particles include a plurality of types of resin fine particles. In the first resin fine particles, at least one type of resin contains a quaternary ammonium compound. Owing to at least one type of resin in the first resin fine particles containing a quaternary ammonium compound, the sea-like region of the shell layer can be given positive chargeability, and this helps improve the charging properties (positive chargeability) of the toner. Preferred as a quaternary ammonium compound monomer contained in the first resin fine particles is a quaternary ammonium compound monomer containing a (meth)acryloyl group, particularly preferred being (meth)acrylamide alkyl trimethyl ammonium salts (more specifically such as (3-acrylamide propyl) trimethyl ammonium chloride) or (meth)acryloyl oxy alkyl trimethyl ammonium salt (more specifically such as 2-(methacryloyl oxy) ethyl trimethyl ammonium chloride). The proportion of the first resin fine particles containing the quaternary ammonium salt compound in the total amount of first resin fine particles is preferably 3% or more.

The second resin fine particles at least include silicone resin. Owing to the second resin fine particles containing silicone resin, the bumps of the shell layer exhibit low adhesion, and this enhances the effect of the bumps serving as a spacer. As a result, the toner is more easily transferred from the photosensitive drum to the intermediate transfer belt or the sheet, leading to improved transfer efficiency.

The average particle size of resin fine particles can be adjusted through the adjustment of polymerization conditions or by a known pulverizing, classifying, or other method. The average particle size of resin fine particles can be measured by measuring the particle size of 50 or more resin fine particles from an electron microscope photograph taken using a field emission scanning electron microscope (“JSM-6700F” produced by JEOL Ltd.) and calculating the number average particle size.

The amount of resin fine particles used is not particularly limited within the scope consistent with the object of the present disclosure. Typically, the amount of resin fine particles used is, for 100 mass parts of the toner core particles, preferably 1 mass parts or more but 20 mass parts or less, and more preferably 3 mass parts or more but 15 mass parts or less. With too small an amount of resin fine particles used, the entire surface of the toner core particle may not be coated with the resin fine particles. Without the entire surface of the toner core particle coated with the resin fine particles, the toner tends to agglomerate during storage at high temperature, leading to poor heat-resistant preservation properties. With too large an amount of resin fine particles used, the shell layer tends to be thick. This makes it difficult to obtain toner with satisfactory stability.

The mass average molecular weight (Mw) of the resin of which the resin fine particles are formed is not particularly limited within the scope consistent with the object of the present disclosure. Typically, the mass average molecular weight is preferably 20,000 or more but 1,500,000 or less, and more preferably 200,000 or more but 400,000 or less. The mass average molecular weight (Mw) of the resin as the material of the resin fine particles can be measured by gel permeation chromatography according to a known method.

The method for polymerizing the monomer mentioned above is not particularly limited within the scope consistent with the object of the present disclosure; any of methods such as solution polymerization, bulk polymerization, emulsion polymerization, and suspension polymerization can be selected.

In a case where a monomer with an unsaturated bond is addition-polymerized using an aqueous medium as by emulsion polymerization or suspension polymerization, a surfactant can be used. The surfactant used is not particularly limited within the scope consistent with the object of the present disclosure and can be appropriately selected from the group consisting of anionic surfactants, cationic surfactants, and nonionic surfactants. Examples of anionic surfactants include sulfate ester salt-type surfactants, sulfonic acid salt-type surfactants, phosphate ester salt-type surfactants, and soap. Examples of cationic surfactants include amine salt-type surfactants and quaternary ammonium salt-type surfactants. Examples of nonionic surfactants include polyethylene glycol-type surfactants, alkyl phenol ethylene oxide adduct-type surfactants, and polyhydric alcohol-type surfactants that are derivatives of polyhydric alcohols such as glycerol, sorbitol, and sorbitan. Among these surfactants, it is preferable to use at least one of an anionic surfactant and a nonionic surfactant. Among those surfactants, one type can be used or two or more types can be used in combination.

### (External Additive)

The toner according to the present disclosure can, if so desired, be treated with an external additive after the shell layer has been formed on the surface of the toner core particle. In the following description, a particle to be treated with the external additive is occasionally referred to as “toner base particle.”

The type of external additive used is not particularly limited within the scope consistent with the object of the present disclosure and can be selected appropriately from external additives that are known to be used in toner. Specific examples of suitable external additives include silica and metal oxides such as alumina, titanium oxide, magnesium oxide, zinc oxide, strontium titanate, and barium titanate. Two or more of these external additives can be used in combination.

The particle size of the external additive is not particularly limited within the scope consistent with the object of the present disclosure; typically it is preferably 0.01 μm or more but 1.0 μm or less.

The amount of external additive used is not particularly limited within the scope consistent with the object of the present disclosure. Typically, the amount of external additive used is, for the total mass of the toner base particles produced by forming the shell layer on the surface of the toner core particle, preferably 0.1 mass % or more but 10 mass % or less, and more preferably 0.2 mass % or more but 5 mass % or less. Too small an amount of external additive used tends to lead to low hydrophobicity of the toner. This makes the toner susceptible to water molecules in air in a high-temperature high-humidity environment and tends to result in a drop in the image density of the formed image due to an extreme drop in the charge amount of the toner as well as a drop in the flowability of the toner and other problems. On the other hand, too large an amount of external additive used can result in a drop in image density due to excessive charging of the toner.

### [Production Method for Toner]

Next, a production method for the toner according to the present disclosure will be described. The production method for the toner is not particularly limited so long as it can form the toner core particle and the shell layer such that each has a predetermined structure. As necessary, external addition treatment can be performed by using as a toner base particle the toner core particle coated with the shell layer to attach an external additive to the surface of the toner base particle. As a suitable production method for the toner described above for development of electrostatic latent images, the following description discusses one by one a method for producing the toner core particle, a method for forming the shell layer, and a method for external addition treatment.

### (Method for Producing the Toner Core Particle)

The method for producing the toner core particle is not particularly limited so long as it can satisfactorily disperse any components such as a colorant, a release agent, a charge control agent, and a magnetic powder in a binder resin. According to one specific example of a suitable method for producing the toner core particle, first, a binder resin is mixed with other components such as a colorant, a release agent, a charge control agent, and a magnetic powder using a mixer or the like; then the binder resin and the components blended with it are melted and kneaded using a uniaxial or biaxial kneader or the like; and then the kneaded product is pulverized and classified. The average particle size of the toner core particle is not particularly limited within the scope consistent with the object of the present disclosure; in general, it is preferably 5 μm or more but 10 μm or less.

### (Method for Forming the Shell Layer)

To form the shell layer that coats the surface of the toner core particle, resin fine particles are attached to the surface of the toner core particle.

A more specific method will be described. First, in a mixing apparatus, hydrochloric acid is added to ion exchange water to prepare an aqueous medium that is weakly acidic (for example, with a pH value selected from the range of three or more but five or less). Subsequently, to the aqueous medium with the so adjusted pH value, as a shell material, a dispersion liquid (suspension) of resin fine particles (first and second resin fine particles) is added along with toner core particles.

Subsequently, while the mixture liquid containing the shell material and the toner core particles is stirred, the temperature of the mixture liquid is raised up to a predetermined holding temperature (e.g., a temperature selected from the range of 50° C. or more but 90° C. or less) at a predetermined rate (e.g., a rate selected from the range of 0.1° C./min or more but 3° C./min or less). Then, while the mixture liquid is stirred, its temperature is held at the holding temperature for a predetermined time (e.g., a length of time selected from the range of 30 minutes or more but 4 hours or less). It is considered that, while the temperature of the mixture liquid is held high, a reaction (fixation of the shell layer) proceeds between the toner core particle and the shell material. The shell material binds to the toner core particle to form the shell layer. The formation of the shell layer on the surface of the toner core particle in the mixture liquid yields a dispersion liquid of toner base particles.

As described above, attaching hydrophobic resin fine particles to the surface of the toner core particle in the mixture liquid and heating the mixture liquid permits the resin fine particles to melt to achieve film formation. Instead, the film formation of the resin fine particles can be promoted by heating them in a drying process, or by subjecting them to physical impact in an external addition process.

After the shell layer is formed as described above, the dispersion liquid of toner base particles is neutralized using, for example, sodium hydroxide. Subsequently, the dispersion liquid of toner base particles is cooled down to, for example, normal temperature (about 25° C.). Then, for example using a Buffner funnel, the dispersion liquid of toner base particles is filtered. This separates the toner base particles from the liquid (solid-liquid separation) to yield the toner base particle in the form of wet cake. Subsequently, the obtained toner base particles in the form of wet cake is washed. Then, the washed toner base particles are dried. After that, as necessary, using a mixier (e.g., an “FM mixer” produced by Nippon Coke & Engineering. Co., Ltd.), the toner base particles and the external additive can be mixed so that the external additive attaches to the surface of the toner base particles. Incidentally, in a case where a spray dryer is used in the drying process, by spraying a dispersion liquid of the external additive (e.g., silica particles) onto the toner base particles, it is possible to simultaneously perform the drying process and the external addition process.

The processes involved in the above-described production method for toner and their order can be modified freely to suit the desired configuration, properties, or the like of the toner. After the external addition process, the toner can be sieved. Any unnecessary process can be omitted. For example, in a case where a commercially available product can as it is be used as a material, using the commercially available product helps omit the process to prepare that material. In a case where, with no adjustment of the pH value of the mixture liquid, the reaction for forming the shell layer proceeds satisfactorily, the pH value adjustment process can be omitted. In a case where no external additive is attached to the surface of the toner base particles (in a case where the external addition process is omitted), the toner base particle corresponds to the toner particle. For efficient production of toner, it is preferable to produce a large number of toner particles simultaneously. Simultaneously produced toner particles are considered to have substantially an identical configuration.

### (Method for External Addition Treatment)

The method for treatment of the toner base particle with the external additive is not particularly limited; the toner base particle can be treated by any known method. Specifically, the toner base particle is treated with the external additive using a mixer such as a Henschel mixer or a Nauta mixer under treatment conditions adjusted such that particles of the external additive do not sink into the toner base particle.

The toner according to the present disclosure described above excels in fixing properties and heat-resistant preservation properties. In cases where images are formed for a long period in various environments including a high-temperature high-humidity environment and a low-temperature low-humidity environment, the toner can be charged with the desired amount of charge. Thus, images can be formed with the desired density. Accordingly, the toner according to the present disclosure for development of electrostatic latent images can be used suitably in a variety of image forming apparatuses. Now, the effects of the present disclosure will be described more specifically by way of examples. The present disclosure is not limited in any way by those examples.

### EXAMPLES

### Production Example 1

### (Production of Toner Core Particles)

The following were mixed in a mixer (Henschel mixer) to obtain a mixture: as a binder resin, 750 g of low-viscosity polyester resin (Tg=38° C., Tm=65° C.), 100 g of medium-viscosity polyester resin (Tg=53° C., Tm=84° C.), and 150 g of high-viscosity polyester resin (Tg=71° C., Tm=120° C.); as a release agent, 55 g of carnauba wax (“Carnauba Wax No. 1” produced by S. Kato and Co.); and, as a colorant, 40 g of phthalocyanine blue (“KET Blue 111” produced by DIC Corporation). Next, the mixture was melted and kneaded using a biaxial kneader to obtain a kneaded product. The kneaded product was then coarsely pulverized using a granulator (“Rotoplex” produced by Toa Machine Industry) and was then finely pulverized using a mechanical pulverizer (“Turbomill” produced by Turbo Industry) to obtain a finely pulverized product. The finely pulverized product was then classified using a classifier (“Elbow Jet” produced by Nittetsu Mining Co., Ltd.) to obtain toner core particles with a volume average particle size (D50) of 6.8 μm. The volume average particle size of the toner core particle was measured using a “Coulter Counter Multisizer 3” (produced by Beckman Coulter, Inc.).

### Production Example 2

### (Production of Dispersion Liquids SA1 and SA2 of First Resin Fine Particles)

A three-neck flask with a volume of 1 L provided with a stirrer, a thermometer, a cooling pipe, and a nitrogen introduction pipe was set in a water bath to be used as a reaction vessel. The flask was loaded with 875 g of ion exchange water at 30° C. and 75 g of anionic surfactant (“LATEMUL (registered trademark) WX” produced by Kao Corporation; component: sodium polyoxyethylene alkyl ether sulfate; solid content concentration: 26 mass %). After that, using the water bath, the temperature inside the flask was raised to 80° C. and was then kept at that temperature (80° C.). Subsequently, to the contents of the flask at 80° C., the materials shown in Table 1 were added. Then the temperature inside the flask was kept at 80° C. for another two hours so that the contents of the flask polymerized. Thus, Dispersion Liquids SA1 and SA2 of first resin fine particles with a solid content concentration of 5 mass % were obtained.

TABLE 1

| | | | | | Potassium | Ion Exchange |
|---|---|---|---|---|---|---|
| | Styrene | | BA^{*1} | MMA^{*2} | Persulfate | Water |
| SA1 | 18 | g | 2 g | — | 0.5 g | 30 g |
| SA2 | 19.5 | g | — | 3 g | 0.5 g | 30 g |

^{*1}Butyl acrylate.
^{*2}Methyl methacrylate.

### Production Example 3

### (Production of Dispersion Liquid SN of First Resin Fine Particles Containing a Quaternary Ammonium Compound)

A three-neck flask with a volume of 1 L provided with a stirrer, a thermometer, a cooling pipe, and a nitrogen introduction pipe was set in a water bath to be used as a reaction vessel. The flask was loaded with 90 mL of isobutanol, 100 mL of methyl methacrylate, 35 mL of butyl acrylate, 30 mL of 2-(methacryloyloxy) ethyl trimethyl ammonium chloride (produced by Alfa Aesar), and 6 mL of 2,2′-azobis(2-methyl-N-(2-hydroxyethyl) propionamide) (“VA-086” produced by Wako Pure Chemical Corporation). Subsequently, the contents of the flask were, while being stirred at a stirring rate of 100 rpm, reacted for three hours in a nitrogen atmosphere under the condition of a temperature of 80° C. After that, the flask was additionally loaded with 3 mL of 2,2′-azobis(2-methyl-N-(2-hydroxyethyl) propionamide) (“VA-086” produced by Wako Pure Chemical Corporation) and the contents of the flask were reacted for another three hours in a nitrogen atmosphere under the condition of a temperature of 80° C. to obtain a liquid containing a polymer. Subsequently, the obtained liquid containing the polymer was dried in a reduced-pressure environment under the condition of a temperature of 150° C. The dried polymer was crushed to obtain positively chargeable resin.

Subsequently, a mixing apparatus (“HIVIS MIX 2P-1” produced by PRIMIX Corporation) was loaded with 200 g of the positively chargeable resin obtained as described above along with 184 mL of ethyl acetate (produced by Wako Pure Chemical Corporation). Subsequently, the contents were stirred for one hour at a stirring rate of 20 rpm to obtain a high-viscosity solution. Then, to the obtained high-viscosity solution, an aqueous solution of ethyl acetate etc. was added. The aqueous solution of ethyl acetate etc. was an aqueous solution prepared by dissolving 18 mL of 1N hydrochloric acid, 20 g of anionic surfactant (“EMAL 0” produced by Kao Corporation; component: sodium lauryl sulfate), and 16 g of ethyl acetate (produced by Wako Pure Chemical Corporation) in 562 mL of ion-exchanged water. Adding the aqueous solution of ethyl acetate etc. to the high-viscosity solution yielded Dispersion Liquid SN of first resin fine particles containing a quaternary ammonium compound. The solid content concentration in the dispersion liquid was 20 mass %.

### Production Example 4

### (Production of Dispersion Liquids SS1 to SS7 of Second Resin Fine Particles)

A three-neck flask with a volume of 1 L provided with a stirrer, a thermometer, a cooling pipe, and a nitrogen introduction pipe was set in a water bath to be used as a reaction vessel. The flask was loaded with 875 g of ion exchange water at 30° C. and anionic surfactant (“LATEMUL WX” produced by Kao Corporation; component: sodium polyoxyethylene alkyl ether sulfate; solid content concentration: 26 mass %). After that, using the water bath, the temperature inside the flask was raised to 80° C. and was then kept at that temperature (80° C.). Subsequently, to the contents of the flask at 80° C., the materials shown in Table 2 were added. Then the temperature inside the flask was kept at 80° C. for another two hours so that the contents of the flask polymerized. Used as the silicone resin was 3-methacryloxypropylmethyldimethoxy silane (“KBM 502” produced by Shin-Etsu Chemical Co., Ltd.). The blended amount of anionic surfactant was varied to vary the particle size. Thus, Dispersion Liquids SS1 to SS7 of second resin fine particles containing a silicone resin with a solid content concentration of 5 mass % were obtained. The solid content concentration in the dispersion liquids was adjusted to be 10 mass %.

TABLE 2

| | | | | Silicone | Potassium | Ion Exchange |
|---|---|---|---|---|---|---|
| | Surfactant | Styrene | BA | Resin | Persulfate | Water |
| SS1 | 65 g | 18 g | 2 g | 1.5 g | 0.5 g | 30 g |
| SS2 | 50 g | 18 g | 2 g | 1.5 g | 0.5 g | 45 g |
| SS3 | 40 g | 18 g | 2 g | 1.5 g | 0.5 g | 55 g |
| SS4 | 70 g | 18 g | 2 g | 1.5 g | 0.5 g | 25 g |
| SS5 | 30 g | 18 g | 2 g | 1.5 g | 0.5 g | 65 g |
| SS6 | 50 g | 18 g | 2 g | — | 0.5 g | 45 g |
| SS7 | 45 g | 18 g | 2 g | — | 0.5 g | 50 g |

### [Measuring the Average Particle Size and Tg of Resin Fine Particles]

The products of Production Examples 2 to 4, namely Dispersion Liquids SA1, SA2, and SN of first resin fine particles and Dispersion Liquids SS1 to SS7 of second resin particles, were each dried under reduced pressure and then, for each of them, the glass transition point (Tg) was measured using a differential scanning calorimeter (DSC) and the average particle size was measured using a field emission scanning electron microscope (FE-SEM). The results are shown in Table 3.

TABLE 3

| | Particle Size [nm] | Tg [° C.] |
|---|---|---|
| SA1 | 32 | 71 |
| SA2 | 38 | 69 |
| SN | 35 | 80 |
| SS1 | 70 | 75 |
| SS2 | 110 | 80 |
| SS3 | 150 | 74 |
| SS4 | 50 | 76 |
| SS5 | 200 | 79 |
| SS6 | 110 | 73 |
| SS7 | 130 | 80 |

### Production Example 5

### Production of Toners T1 to T17

### (Forming the Shell Layer)

A three-neck flask with a volume of 1 L provided with a stirrer, a thermometer, a cooling pipe, and a nitrogen introduction pipe was set in a water bath to be used as a reaction vessel. The flask was loaded with 100 g of ion exchange water. After that, using the water bath, the temperature inside the flask was kept at 30° C. Subsequently, diluted hydrochloric acid was added into the flask to adjust the pH value of the liquid in the flask to four. Subsequently, the flask was additionally loaded with one of Dispersion Liquids SA1 and SA1 of first resin fine particles obtained in Production Example 2, Dispersion Liquid SN of first resin fine particles containing a quaternary ammonium compound obtained in Production Example 3, and one of Dispersion Liquids SS1 to SS7 of second resin fine particles obtained in Production Example 4. Dispersion Liquids SA1 and SA1 were added in weights expected to achieve the toner coverage ratios listed in Table 4; Dispersion Liquids SS1 to SS7 were either added in weights expected to achieve the toner coverage ratios listed in Table 4 or not added. Dispersion Liquid SN was either added in the quantity listed in Table 4 or not added. The toner coverage ratio was calculated as the ratio, to the specific surface area of the toner, the sum of the projection areas of resin fine particles as calculated from their primary particle size.

Subsequently, the flask was additionally loaded with 300 g of the toner core particles obtained in Production Example 1 and the contents of the flask were stirred for one hour at a rotation rate of 200 rpm. After that, the flask was additionally loaded with 300 g of ion exchange water. Subsequently, while the mixture in the flask was stirred at a rotation rate of 100 rpm, the temperature inside the flask was raised up to 70° C. at a rate of 1° C./min. Subsequently, under the conditions of a temperature of 70° C. and a rotation rate of 100 rpm, the mixture was stirred for two hours. Subsequently, sodium hydroxide was added into the flask to adjust the pH value of the contents of the flask to seven. Subsequently, the contents of the flask were cooled down to normal temperature (about 25° C.) to obtain a dispersion liquid containing toner base particles. The added amounts of Dispersion Liquids SA1, SA2, SN, and SS1 to SS7 for 100 g of toner core particles are listed in Table 4.

TABLE 4

| | | | | | | | | | | | | Coverage Ratio | | |
|---|---|---|---|---|---|---|---|---|---|---|---|---|---|---|
| | | 1st Resin Fine Particles | | | 2nd Resin Fine Particles | | | | | | | [%] | | |
| | Toner | SA1 | SA2 | SN | SS1 | SS2 | SS3 | SS4 | SS5 | SS6 | SS7 | SA, SN | SS | Notes |
| Practical | T1 | 44 | | 1.5 | 10 | | | | | | | 95 | 20 | |
| Example 1 | | | | | | | | | | | | | | |
| Practical | T2 | 44 | | 1.5 | | 16 | | | | | | 95 | 20 | |
| Example 2 | | | | | | | | | | | | | | |
| Practical | T3 | 48 | | 1.5 | | 8 | | | | | | 103 | 10 | SS coverage a |
| Example 3 | | | | | | | | | | | | | | bit low |
| Practical | T4 | 30 | | 1.5 | | 35 | | | | | | 65 | 42 | SS coverage a |
| Example 4 | | | | | | | | | | | | | | bit high |
| Practical | T5 | 44 | | 1.5 | | | 23 | | | | | 98 | 20 | |
| Example 5 | | | | | | | | | | | | | | |
| Practical | T6 | 33 | | 1.5 | | 16 | | | | | | 71 | 20 | |
| Example 6 | | | | | | | | | | | | | | |
| Practical | T7 | | 42 | 1.5 | | 16 | | | | | | 95 | 20 | |
| Example 7 | | | | | | | | | | | | | | |
| Practical | T8 | 44 | | 0.5 | | 16 | | | | | | 95 | 20 | SN amount a bit |
| Example 8 | | | | | | | | | | | | | | low |
| Practical | T9 | 44 | | 2.5 | | 16 | | | | | | 95 | 20 | SN amount a bit |
| Example 9 | | | | | | | | | | | | | | high |
| Comparative | T10 | 48 | | 1.5 | | 6 | | | | | | 103 | 8 | SS coverage too |
| Example 1 | | | | | | | | | | | | | | low |
| Comparative | T11 | 26 | | 1.5 | | 45 | | | | | | 55 | 55 | SS coverage too |
| Example 2 | | | | | | | | | | | | | | high |
| Comparative | T12 | 44 | | 1.5 | | | | 8 | | | | 95 | 20 | SS particle size |
| Example 3 | | | | | | | | | | | | | | out of range |
| Comparative | T13 | 44 | | 1.5 | | | | | 30 | | | 95 | 20 | SS particle size |
| Example 4 | | | | | | | | | | | | | | out of range |
| Comparative | T14 | 44 | | 1.5 | | | | | | 16 | | 95 | 20 | No silicone in SS |
| Example 5 | | | | | | | | | | | | | | |
| Comparative | T15 | 44 | | 1.5 | | | | | | | 19 | 95 | 20 | No silicone in SS |
| Example 6 | | | | | | | | | | | | | | |
| Comparative | T16 | 44 | | 1.5 | | | | | | | | 95 | 0 | No SS |
| Example 7 | | | | | | | | | | | | | | |
| Comparative | T17 | 44 | | | | 16 | | | | | | 95 | 20 | No SN |
| Example 8 | | | | | | | | | | | | | | |

### (Washing and Drying Processes)

The obtained dispersion liquid containing toner base particles was filtered, washed, and dried to obtain toner base particles.

### (External Addition Treatment)

For 100 g of the obtained toner base particles, 0.8 mass parts of hydrophobic silica (“RA-200H” produced by Nippon Aerosil Co., Ltd.) and 0.8 mass parts of titanium oxide (“EC-100” produced by Titan Kogyo, Ltd.) were added. Using a blender-mixer (“Blender 7011HS” produced by WARING Products, Inc.), these were stirred and mixed for 40 seconds at a rotation rate of 18000 rpm, and then agglomerates were filtered out with a mesh of 75 μm to obtain Toners T1 to T17.

### [Evaluating Toner's Heat-Resistant Preservation Properties, Fixing Properties, Charge Amount, Transfer Efficiency, and Image Density]

With each of the toners of Practical Examples 1 to 9 (T1 to T9) of the present disclosure and the toners of Comparative Examples 1 to 8 (T10 to T17), its heat-resistant preservation properties, fixing properties, charge amount, transfer efficiency, and image density were evaluated by the methods described below.

### (Heat-Resistant Preservation Properties)

A plastic vessel with a volume of 20 cc was loaded with 3 g of toner (T1 to T17) to be left under controlled temperature and humidity for 12 hours or more in a normal-temperature normal-humidity environment (23° C., 50% RH), and was then left to stay for three hours in a drying oven set to 58° C. to obtain toner for measurement. The toner was then cooled to normal temperature and was then, using a powder tester (produced by Hosokawa Micron Corporation), sieved for 30 seconds under the conditions of level 5 on the vibration scale and a mesh opening of 150 μm to determine the remaining amount on the mesh in terms of percentage. If the remaining amount was 10% or less, the sample was evaluated as acceptable.

### (Fixing Properties)

First, using a ball mill, 100 mass parts of carrier for developer (carrier for “FSC525oDN,” produced by Kyocera Document Solutions) and 10 mass parts of a sample (Toners T1 to T17) were mixed for 30 minutes to obtain evaluation developer (two-component developer). The evaluation machine used was a color printer (“FCS5250DN” produced by Kyocera Document Solutions) provided with a fixing device (with a nip width of 8 mm) of a heating-pressing type employing a roller-roller design, and was a version modified to provide variable fixing temperature. The evaluation developer was loaded in the developing device of the evaluation machine and the sample (replenishment toner) was loaded in the toner container of the evaluation machine.

Using the above evaluation machine, in a normal-temperature normal-humidity environment (23° C., 50% EH), a solid (evenly dense) image of a size of 25 mm by 25 mm was formed on a sheet with a basis weight of 90 g/m² (plain paper of A4 size) under the conditions of a linear velocity of 200 mm/second and a deposited toner amount of 1.0 mg/cm². The sheet having the image formed on it was then passed through the fixing device of the evaluation machine. The nip passage time was 40 milliseconds.

Within the range of fixing temperature of 120° C. or more but 150° C. or less, the minimum temperature (minimum fixing temperature) at which the solid image (toner image) was satisfactorily fixed to the sheet was measured. Whether the toner was satisfactorily fixed was checked by a fold-and-rub test. Specifically, the evaluation sheet having passed through the fixing device was folded with the image side in and the image on the fold line was rubbed, with a weight of 1 kg wrapped in cloth, back and forth five times. Subsequently, the sheet was unfolded and the folded part (the part where the solid image was formed) of the sheet was inspected. Then, in the folded part, the length (dropout length) over which the toner had come off was measured. The lowest among the fixing temperatures at which the dropout length was 1 mm or less was taken as the minimum fixing temperature. If the minimum fixing temperature was 140° C. or less, the sample was evaluated as acceptable.

### (Charge Amount, Transfer Efficiency, and Image Density in a Predetermined Environment)

First, using a ball mill, 100 mass parts of carrier for developer (carrier for “TASKalfa5250DN,” produced by Kyocera Document Solutions) and 10 mass parts of a sample (Toners T1 to T17) were mixed for 30 minutes to obtain evaluation developer (two-component developer). The evaluation machine used was a color printer (“TASKalfa5250DN” produced by Kyocera Document Solutions). The evaluation developer was loaded in the developing device of the evaluation machine and the sample (replenishment toner) was loaded in the toner container of the evaluation machine.

### (Charge Amount)

Using the above evaluation machine, in a normal-temperature normal-humidity environment (N/N environment: 23° C., 50% EH), a durable printing test was performed in which 100,000 sheets were printed continuously at a print ratio of 5%. Meanwhile, at an initial stage and after the printing of 100,000 sheets (after durability printing), the charge amount of the toner in the developer was measured. The charge amount of the toner in the developer was measured using a charge measurement system (Q/M Meter “Model 210HS-1” produced by Trek Inc.). If the charge amount was 20 to 35 μC/g, the sample was evaluated acceptable.

### (Transfer Efficiency)

As in the measurement of the charge amount, at an initial stage and after the printing of 100,000 sheets (after durability printing), the transfer efficiency was measured. The transfer efficiency was calculated according to Expression (1) below, where Md is the weight of toner on the photosensitive drum and Mp is the weight of toner on the sheet both as observed when a solid image (evaluation image) of vertically 0.5 cm and horizontally 20 cm was output. The weight Md of toner on the photosensitive drum and the weight Mp of toner on the sheet were each measured with the evaluation machine stopped immediately after development, immediately before fixing, in a condition where the solid image on the photosensitive drum and on the sheet could be visually checked, by collecting the toner and measuring its weight on a precision balance. If the transfer efficiency was 88% or more, the sample was evaluated acceptable.

$$Transfer Efficiency ( \% ) = Mp / Md \times 100 \qquad ( 1 )$$

### (Image Density)

As in the measurement of the charge amount and the transfer efficiency, at an initial stage and after the printing of 100,000 sheets (after durability printing), the image density was measured. The image density was calculated as the average value (ID) of the image densities in five spots, each a solid image of vertically 1 cm and horizontally 1 cm, output on a sheet. The image density was measured using a reflection density sensor (“GretagMacbeth SpectroEye” produced by GretagMacbeth Ltd.). If the average value of image density was 1.4 or more, the sample was evaluated as acceptable.

The results of the evaluation of the heat-resistant preservation properties, fixing properties, charge amount, transfer efficiency, and image density of the toners of Practical Examples 1 to 9 and Comparative Examples 1 to 8 are listed in Table 5.

TABLE 5

| | | Heat-Resistant | Minimum | Charge Amount | | Transfer Efficiency | | Image Density | |
|---|---|---|---|---|---|---|---|---|---|
| | | Preservation | Fixing | [μC/g] | | [%] | | [ID] | |
| | | Properties | Temp. | | After | | After | | After |
| | Toner | [%] | [° C.] | Initially | Durability | Initially | Durability | Initially | Durability |
| Practical | T1 | 8 | 134 | 26 | 27 | 90 | 90 | 1.45 | 1.45 |
| Example 1 | | | | | | | | | |
| Practical | T2 | 7 | 136 | 25.8 | 28.1 | 92 | 93 | 1.48 | 1.49 |
| Example 2 | | | | | | | | | |
| Practical | T3 | 6 | 136 | 27.8 | 26.3 | 88 | 89 | 1.43 | 1.44 |
| Example 3 | | | | | | | | | |
| Practical | T4 | 7 | 140 | 22.4 | 20.2 | 93 | 94 | 1.48 | 1.5 |
| Example 4 | | | | | | | | | |
| Practical | T5 | 7 | 138 | 24.5 | 27.6 | 93 | 93 | 1.48 | 1.48 |
| Example 5 | | | | | | | | | |
| Practical | T6 | 10 | 130 | 27.8 | 30.2 | 89 | 92 | 1.44 | 1.47 |
| Example 6 | | | | | | | | | |
| Practical | T7 | 9 | 140 | 24.8 | 28 | 90 | 91 | 1.43 | 1.45 |
| Example 7 | | | | | | | | | |
| Practical | T8 | 4 | 135 | 20.5 | 22.3 | 88.1 | 89 | 1.4 | 1.44 |
| Example 8 | | | | | | | | | |
| Practical | T9 | 10 | 138 | 31.1 | 33.9 | 90.1 | 91 | 1.49 | 1.48 |
| Example 9 | | | | | | | | | |
| Comparative | T10 | 9 | 128 | 28.3 | 24.2 | 85 | 83 | 1.38 | 1.36 |
| Example 1 | | | | | | | | | |
| Comparative | T11 | 9 | 148 | 18.6 | 16.9 | 95 | 95 | 1.53 | 1.53 |
| Example 2 | | | | | | | | | |
| Comparative | T12 | 10 | 132 | 21.2 | 17.3 | 86 | 84 | 1.39 | 1.36 |
| Example 3 | | | | | | | | | |
| Comparative | T13 | 8 | 144 | 25.5 | 28.8 | 94 | 93 | 1.5 | 1.48 |
| Example 4 | | | | | | | | | |
| Comparative | T14 | 8 | 134 | 30.1 | 33.5 | 85 | 84 | 1.35 | 1.36 |
| Example 5 | | | | | | | | | |
| Comparative | T15 | 9 | 134 | 33.2 | 34.9 | 87 | 85 | 1.41 | 1.37 |
| Example 6 | | | | | | | | | |
| Comparative | T16 | 28 | 128 | 31.3 | 27.8 | 76 | 74 | 1.21 | 1.18 |
| Example 7 | | | | | | | | | |
| Comparative | T17 | 8 | 134 | 12.1 | 10.1 | 79 | 76 | 1.3 | 1.27 |
| Example 8 | | | | | | | | | |

As will be understood from Table 5, good transfer efficiency and image density were obtained in Practical Examples 1 to 9, where the average particle size of the second resin fine particles containing a silicone resin and forming bumps of the shell layer was comparatively large (70 to 150 nm) and the coverage ratio with the second resin fine particles (the ratio of coverage of the surface of the toner core particle with the bumps) was comparatively high, namely 10 to 42%.

In particular, notably good transfer efficiency and image density after durability, namely 90% or more and 1.45 or more respectively, were obtained in Practical Examples 1, 2, 4, 5, 7, and 9, where the coverage ratio with the first resin fine particles (the ratio of coverage of the surface of the toner core particle with the sea-like region) was 80% or more, the coverage ratio with the second resin fine particles was 20% or more, and the proportion of the first resin fine particles containing a quaternary ammonium compound in all the first resin fine particles was 3% or more.

By contrast, the desired transfer efficiency and image density were not obtained in Comparative Example 1, where the blended amount of second resin fine particles was small and the coverage ratio with them was less than 10%, not in Comparative Example 3, where the particle size of the second resin fine particles was less than 70 mm (SS4).

Nor were the desired transfer efficiency and image density obtained in Comparative Examples 5 and 6, where, while the average particle size was more than 100 nm, the second resin fine particles (SS6, SS7) did not contain a silicone resin. This is considered to be because, with the second resin fine particles containing no silicone resin, the bumps of the shell layer had high adhesion and did not provide a satisfactory effect as a spacer, making it difficult for the toner to be transferred from the photosensitive drum to the intermediate transfer belt or the sheet.

In Comparative Example 4, where the second resin fine particles (SS5) with an average particle size of 200 nm were used, the particle size of the second resin fine particles containing a silicone resin were too large: a large amount of them had to be blended to achieve an adequate coverage ratio, resulting in poor low-temperature fixing properties. In Comparative Example 2, where, while the particle size was adequate, the coverage ratio was excessive, the toner had poor charging properties (positive chargeability) under the influence of negative chargeability ascribable to the silicone resin.

The above results lead to a conclusion that, in a case where the second resin fine particles forming the bumps of the shell layer contain a silicone resin, the second resin fine particles need to be used with their particle size and coverage ratio at adequate levels. Specifically, the particle size of the second resin fine particles is preferably 70 nm or more but 150 nm or less, and their coverage ratio is preferably 10% or more but 50% or less, and more preferably 20% or more but 50% or less.

In Comparative Example 7, where no second resin fine particles (SS1 to SS7) were blended, the shell layer had no bumps and the surface of the toner thus had high adhesion, resulting in poor heat-resistant preservation properties, transfer efficiency, and image density.

In Comparative Example 8, where the first resin fine particles forming the sea-like region of the shell layer did not contain first resin fine particles containing a quaternary ammonium compound, the toner had poor charging properties and the desired transfer efficiency and image density were not obtained. These results confirm that a quaternary ammonium compound contained in the first resin fine particles forming the sea-like region of the shell layer contributes to improvement of the charging properties (positive chargeability) of the toner.

The present disclosure finds applications in toner for development of electrostatic latent images for use in an electrophotographic method. Based on the present disclosure it is possible to provide toner for development of electrostatic latent images that has good charging properties and low-temperature fixing properties and that can keep good transferring properties.

What is claimed is:

1. Toner for development of an electrostatic latent image, having a toner particle comprising:
a toner core particle containing, at least, a binder resin, a release agent, and a colorant; and
a shell layer that coats the toner core particle,
wherein
the shell layer is formed of resin fine particles containing a vinyl-based resin,
the resin fine particles include a plurality of types of first resin fine particles and second resin fine particles with a larger average particle size than the first resin fine particles,
the shell layer has:
a sea-like region formed of the plurality of types of first resin fine particles; and
island-like bumps formed of the second resin fine particles and spread across the sea-like region,
at least one type of the plurality of types of first resin fine particles contains a quaternary ammonium compound and the second resin fine particles contain a silicone resin,
an average particle size of the second resin fine particles is 70 nm or more but 150 nm or less, and
a ratio of coverage of a surface of the toner core particle with the bumps is 10% or more but 50% or less.

2. The toner according to claim 1, wherein
the ratio of coverage of the surface of the toner core particle with the bumps is 20% or more but 50% or less.

3. The toner according to claim 1, wherein
a ratio of coverage of the surface of the toner core particle with the sea-like region is 80% or more.

4. The toner according to claim 1, wherein
a proportion of the first resin fine particles containing the quaternary ammonium compound in all the first resin fine particles is 3% or more.

5. The toner according to claim 1, wherein
the toner core particle contains polyester resin as the binder resin; and
the first and second resin fine particles are formed of styrene-acrylic resin containing a styrene-based monomer and one or more types of acrylic acid-based monomers.
